(19) United States
(12) Patent Application Publication
(10) Pub. No.: US 2003/0185958 A1
(43) Pub. Date: Oct. 2, 2003

(54) Dipping sauce and method of preparation

(76) Inventor: Bruce Wood, Tallahassee, FL (US)

Correspondence Address: Carnes, Cona & Dixon, Innovation Park, 1736 West Paul Dirac Drive, Tellahassee, FL, 32308, US

(21) Appl. No.: 10/113,092

(22) Filed: Apr. 1, 2002

(51) Int. Cl. A23L 1/238

(52) U.S. Cl. 426/589

(57) ABSTRACT

A dipping sauce includes generally egg, mayonnaise, sugar, distilled water, salt, vegetable oil, sour cream, lime juice, horseradish sauce, slaw dressing, sandwich and salad sauce, and soy. A method of preparing the dipping sauce includes combining an interim mixture with a second interim mixture which is agitated to form a homogeneous status.

### BACKGROUND OF THE INVENTION

1. Field of the Invention

The present invention relates generally to a novel and unique distinctive tasting dipping sauce and method of preparation, and more particularly, to a tasty dipping sauce which offers “something different” and which will compliment the flavor of seafood, poultry, steak, sandwiches, snacks, hors d'oeuvres and other gastronomical delights.

2. Description of the Prior Art

Throughout the United States steps are being taken to search for an out-of-the-ordinary dipping sauce capable of exciting the palate in only one or two bites. The constant goal for snacks, hors d'oeuvres and appetizers is to avoid the pitiful displays of those foods that have become synonymous with the run-of-the-mill entertaining. Many of the prior art dipping sauces are limited in their use and do not offer out-of-the-ordinary flavor combinations. In addition, many sauces have a runny consistency, which makes them unsuitable for spreading on a sandwich or for dipping.

Dipping sauces are well known in the prior art. By way of example, U.S. Pat. No. 6,074,683 issued to Rosing et al discloses a process for preparing a savory flavor. Patent '683 is concerned with savory flavors that resemble that of roast, fried or boiled meat.

U.S. Pat. No. 6,183,793 issued to Merritt et al discloses a baked bean food product and method of making which includes ketchup and maple syrup, Worcestershire sauce, dark brown sugar, cayenne pepper, black pepper, pork and beans, smoked onions and smoked pork. Upon obtaining the final mixture of the ingredients, the final mixture is smoked for a period of time prior to serving.

U.S. Pat. No. 5,885,644 issued to Dean discloses a garlic sauce and method of preparation. The garlic sauce disclosed in this patent is prepared without the addition of exogenous starch and provides a uniformly chunky, crunchy, and spreadable sauce.

None of the previous efforts, however, provide the benefits intended with the present invention. Additionally, prior techniques do not suggest the present inventive combination of component elements as disclosed herein. The present invention achieves its intended purposes, objectives and advantages over the prior art through a new, useful and unobvious combination of component elements, which is simple to use with the utilization of a minimum number of component elements and by employing only readily available materials.

### SUMMARY OF THE INVENTION

The present invention provides for a novel and unique distinctive dipping sauce and method of preparation, as defined within the summary and specific embodiments as disclosed herein. For the purpose of summarizing the present invention, the invention may be incorporated into a dipping sauce, as well as a method of preparation of a dipping sauce which compliments the flavor of seafood, poultry, steak, sandwiches, snacks, hors d'oeuvres and the like. In general, in the preferred embodiment of the present invention, the invention features a dipping sauce including eggs, mayonnaise, sugar, distilled water, salt, vegetable oil, sour cream, lime, horseradish and soy.

It has been determined that by preparing the dipping sauce with the ingredients listed above, a tasty dipping sauce which offers “something different” in terms of a unique distinctive flavor.

Specifically, the composition comprises a horseradish sauce ingredient such as the Kraft Horseradish Sauce which is well known, comprised of the following: water, soy bean oil, sugar, vinegar, egg yolks, starch, contains less than 2% of salt, modified food starch, natural flavor horseradish, spice guarm, paprika, hydrolyzed corn gluten, garlic, onion, artificial flavor, oleoresin paprika, and the composition also comprises a slaw dressing ingredient one of which is well known, Marzetti, the original Slaw Dressing comprised of the following: soy bean oil, corn-cidar vinegar, sugar, fructose corn syrup, egg yolk, salt, spice, water, xanthan gum, and the composition also comprises a sandwich and salad sauce such as Durkees Famous Sandwich and Salad Sauce which is well known and comprises soy bean oil, white vinegar, water, sugar, mustard, salt, whole egg solids, modified food starch, spice extractives and xanthan gum and the final composition ingredient is limejuice.

The composition is prepared by taking the desired amount of Kraft's Horseradish Sauce and placing the Kraft Horseradish Sauce in a mason jar. Then the proper amount of Marzetti the Original Slaw Dressing is added to the Kraft Horseradish Sauce and an interim mixture is formed and stirred with a mechanical stirrer until the inner mixture is homogeneous in texture. Then the Durkee Famous Sandwich and Salad Sauce is added to the interim mixture to form a second interim mixture and that second interim mixture is agitated until the second interim mixture achieves a homogeneous status. Immediately after achieving homogeneous status the limejuice is added to the second interim mixture to form a final product which is also stirred with the mechanical stirrer until a homogeneous state is achieved. Thereafter, the final product is transferred to containers via a filling line for shipment to distribution centers. The key to the efficacy and tasty flavor of the product is the ratio of the horseradish sauce, the slaw dressing and the sandwich and salad sauce and the limejuice to the final product.

In an alternative embodiment the invention features a dipping sauce which may include roasted garlic.

In yet another alternative embodiment, the dipping sauce may include pickled pepper which provides for a sauce primarily comprised of Worcestershire sauce and further compliments the flavor of steak.

In yet another alternative embodiment, the dipping sauce may include onion and honey.

Therefore it is a major object of the present invention to provide for a dipping sauce which compliments the flavor of seafood, poultry, steak, snacks, hors d'oeuvres and the like.

It is a further object of the present invention to provide for a distinctive dipping sauce thereof which will provide for “something different” and an out-of-the-ordinary flavor combination capable of exciting the palate.

Yet another object of the present invention is to provide a method of preparation of a unique and novel distinctive dipping sauce.

Still another object of the instant invention is to provide for a distinctive dipping sauce which is quick and easy to use and provides for a gastronomical delight.

The foregoing has outlined rather broadly the more pertinent and important features of the present invention in order that the detailed description of the invention that follows may be better understood so that the present contribution to the art can be more fully appreciated. Additional features of the invention will be described hereinafter, which form the subject of the invention. It should be appreciated by those skilled in the art that the conception and the specific embodiments disclosed may be readily utilized as a basis for modifying or comprising other combinations for providing the same purposes of the present invention. It should also be realized by those skilled in the art that such equivalent combinations do not depart from the spirit and scope of the invention. Other advantages and features will become apparent from the following detailed description of the invention.

### DETAILED DESCRIPTION OF THE PREFERRED EMBODIMENT

The present invention provides for a unique and novel distinctive dipping sauce composition as well as a method for preparation thereof which can be used to compliment seafood, poultry, steak, snacks, sandwiches, hors d'oeuvres and the like. The composition of the present invention is designed and formulated to be readily used by the consumer.

In the preferred embodiment, for enabling a composition to be used for the distinctive dipping sauce and method of preparation thereof, the composition will be of medium thickness salad dressing form thereby providing the distinctive dipping sauce to have a smooth, spreadable, but not a mayonnaise like consistency. The ingredients for the preferred embodiment of the instant dipping sauce invention include generally, eggs, mayonnaise, sugar, distilled water, salt, vegetable oil, sour cream, limejuice, horseradish, and soy.

Specifically, the composition comprises a Horseradish Sauce ingredient such as the Kraft orseradish sauce which is well known, comprised of the following: water, soy bean oil, sugar, vinegar, egg yolks, starch, contains less than 2% of salt, modified food starch, natural flavor horseradish, spice guarm, paprika, hydrolyzed corn gluten, garlic, onion, artificial flavor, oleoresin paprika, and the composition also comprises a slaw dressing ingredient one of which is well known, Marzetti, the original Slaw Dressing comprised of the following: soy bean oil, corn-cidar vinegar, sugar, fructose corn syrup, egg yolk, salt, spice, water, xanthan gum, and the composition also comprises a sandwich and salad sauce such as Durkee Famous Sandwich and Salad Sauce which is well known and comprises soy bean oil, white vinegar, water, sugar, mustard, salt, whole egg solids, modified food starch, spice extractives and xanthan gum and the final composition ingredient is limejuice.

The composition is prepared by taking nine fluid ounces of Kraft Horseradish sauce or the like, and combining it with sixteen fluid ounces of Marzetti The Original Slaw Dressing or the like, and then this interim mixture is formed and stirred with a mechanical stirrer until the interim mixture is homogeneous in texture. Then the ten ounces of Durkee Famous Sandwich and Salad Sauce or the like is added to the interim mixture to form a second interim mixture and the second interim mixture is agitated until the second interim mixture achieves a homogeneous status. Immediately after achieving homogeneous status, limejuice from one half a lime is added to the second interim mixture to form a final product which is also stirred with a mechanical stirrer until a homogeneous state is achieved with the mixture. Thereafter the final product is transferred to containers via a filling line for shipment to distribution centers. The key to the efficacy and tasty flavor of the product is the ratio of the horseradish sauce, the slaw dressing and the sandwich and salad sauce and the lime to the final product.

In an alternative embodiment the invention features a dipping sauce which may include roasted garlic.

In yet another alternative embodiment, the dipping sauce may include pickled pepper which provides for a sauce primarily comprised of Worcestershire sauce and further compliments the flavor of steak.

In yet another alternative embodiment, the dipping sauce may include onion and honey.

The sauce has an appealing and improved taste and can be served as a dipping sauce with a variety of different foods. The sauce as taught in the present invention has a unique flavor that is obtained in significant part by combining the eggs, mayonnaise, sugar, distilled water, salt, vegetable oil, sour cream, lime, horseradish, and soy.

The horseradish sauce, the slaw dressing sauce and the sandwich and salad sauce may be conventional in several of the embodiments of the present invention and may comprise natural materials, synthetic agents or a combination thereof to provide for a medium texture such like that of a salad dressing and which provides for a distinctive and tasty dipping sauce. It is noted the Krafts Horseradish Sauce, Marzetti The Original Slaw Dressing and Durkee Famous Sandwich and Salad Sauce have been utilized to produce excellent results. Other sauces which are commercially available may also be employed in the present invention.

While the invention has been particularly shown and described with reference to an embodiment thereof, it will be understood by those skilled in the art that various changes in form and detail may be made without departing from the spirit and scope of the invention.

I claim:

1. A dipping sauce comprising the following ingredients:
a) eggs;
b) mayonnaise;
c) sugar;
d) distilled water;
e) salt;
f) vegetable oil;
g) sour cream;
h) lime juice;
i) horseradish sauce;
j) slaw dressing;
k) sandwich and salad sauce; and
k) soy,
wherein said ingredients are combined until the mixture is homogeneous in texture.

2. The dipping sauce of claim 1, wherein said horseradish sauce is comprised of water, soybean oil, sugar, vinegar, egg yolks, starch, contains less than 2% of salt, modified food starch, natural flavor horseradish, spice warm paprika, hydrolyzed corn gluten, garlic, onion, artificial flavor, and oleo resin paprika.

3. The dipping sauce of claim 1, wherein said slaw dressing is comprised of soy bean oil, corn-cidar, vinegar, sugar, fructose corn syrup, egg yolk, salt, spice, water, and xanthan gum.

4. The dipping sauce of claim 1, wherein said sandwich and salad sauce is comprised of soy bean oil, white vinegar, water, sugar, mustard, salt, hole egg salads, modified food starch, spice extractives, and xantham gum.

5. The dipping sauce of claim 1, wherein said sauce may also be comprised of the following ingredients:
a) roasted garlic
b) pickled pepper
c) Worcestershire sauce
d) onion
e) honey

6. A method of preparing a dipping sauce, comprising the steps of:
a) preparing about 9 fluid ounces of said horseradish sauce;
b) mixing said horseradish sauce with 16 fluid ounces of said slaw dressing, and this said interim mixture is formed and stirred with a mechanical stirrer until the said interim mixture is homogeneous in texture;
c) adding about 10 ounces of said sandwich and salad sauce to the said interim mixture in order to form a second interim mixture and said second interim mixture is agitated until the said interim mixture achieves a homogeneous status; and
d) adding said lime juice from approximately one half a lime to said second interim mixture in order to form a final product which is also stirred with a mechanical stirrer until a homogeneous state is achieved with said mixture.

7. The method of claim 6, wherein said sauce may comprise roasted garlic.

8. The method of claim 6, wherein said sauce may comprise pickled pepper.

9. The method of claim 6, wherein said sauce may comprise Worcestershire sauce.

10. The method of claim 6, wherein said sauce may comprise onion.

11. The method of claim 6, wherein said sauce may comprise honey.
